(19) United States
(12) Patent Application Publication
(10) Pub. No.: US 2013/0036777 A1
(43) Pub. Date: Feb. 14, 2013

(54) WEIGHT MEASURE DEVICE WITH A COMBINATION LOCK

(71) Applicant: CHUN MING LIN, TAICHUNG CITY (TW)

(72) Inventor: CHUN MING LIN, TAICHUNG CITY (TW)

(21) Appl. No.: 13/207,612

(22) Filed: Aug. 11, 2011

(51) Int. Cl. E05B 37/00

(52) U.S. Cl. 70/30

(57) ABSTRACT

A weight measure device includes a casing having a first side connected to a suitcase. A combination lock is received in the casing and an actuator extends into the casing for driving the combination lock. A connector is movably mounted to a second side of the casing for sensing the weight of the suitcase and transmits a signal to an electronic unit that is disposed in the casing. The electronic unit converts the signal from the connector into a weight unit and shown thereon.

### BACKGROUND OF THE INVENTION

1. Field of the Invention

The present invention relates to a weight measure device, and more particularly to a weight measure device with a combination lock used for a suitcase.

2. Description of Related Art

A traveler usually carries several suitcases with different sizes when going aboard. The size and weight of suitcase are seriously limited in customhouse for flight safe. However, an ordinary family has no suitable scale or weight measure device for suitcase. As a result, the suitcase may have a weight that is over maximum of allowance such that an extra freightage cost is necessary. It is a bother for a traveler who wants to go aboard.

Some suitcase manufacturers provide weight measure device to rollers that is mounted onto a bottom of a suitcase for measuring weight of the suitcase. However, the weight measure device is easily broken because the conventional weight measure device always loads the gravity of the suitcase.

The present invention has arisen to mitigate and/or obviate the disadvantages of the conventional method and device for measure the weight of a suitcase.

### SUMMARY OF THE INVENTION

The main objective of the present invention is to provide an improved weight measure device with a combination lock used for a suitcase. The weight measure device can measure the weight of the suitcase anytime and anywhere, in addition, the combination lock can prevent the suitcase from a pickpocket.

To achieve the objective, the weight measure device in accordance with the present invention comprises a hollow casing including a first shell and a second shell abutting each other, wherein a window is defined in the second shell and the casing has a first side adapted to be connected to a suitcase. A combination lock is received in the casing. The combination lock includes multiple rotors respectively rotatably mounted to the casing and an engage assembly selectively engaged to the rotors. An actuator extends into the casing for driving the engage assembly, wherein the actuator is reciprocally movable relative to the engage assembly. A connector is movably mounted onto a second side of the casing, a connecting board extends from the connector into the casing, and a strain gauge has a first end connected to a free end of the connecting board and a second end secured on the casing. An electronic unit is disposed in the casing and electrically connected to the strain gauge. The electronic unit includes a battery received in the casing for providing power thereto, a processing unit electrically connected to the battery and the strain gauge and a displayer electrically connected to the processing unit and corresponding to the window. A strap is connected to the connector such that the sensor is deformed due to the gravity of the suitcase when the operator carries the suitcase with the strap to make the suitcase in a suspensory condition, wherein the deform ratio of the sensor is transmitted to the processing unit and the processing unit converts the deform ratio of the sensor into a weight unit and shown on the displayer.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a weight measure device with a combination lock in accordance with the present invention;

FIG. 2 is a perspective view of the weight measure device with a combination lock in accordance with the present invention;

FIG. 3 is a top plan view of the weight measure device in FIG. 2 when a first shell is removed;

FIG. 4 is a first schematic view of the weight measure device in accordance with the present invention;

FIG. 5 is a second schematic view of the weight measure device in accordance with the present invention;

FIG. 6 is an exploded perspective view of a second embodiment of the weight measure device with a combination lock in accordance with the present invention;

FIG. 7 is a perspective view of a second embodiment of the weight measure device with a combination lock in accordance with the present invention;

FIG. 8 is an operational view of the weight measure device in FIG. 7; and

FIG. 9 is a schematic view of the weight measure device in FIG. 7.

### DETAILED DESCRIPTION OF THE INVENTION

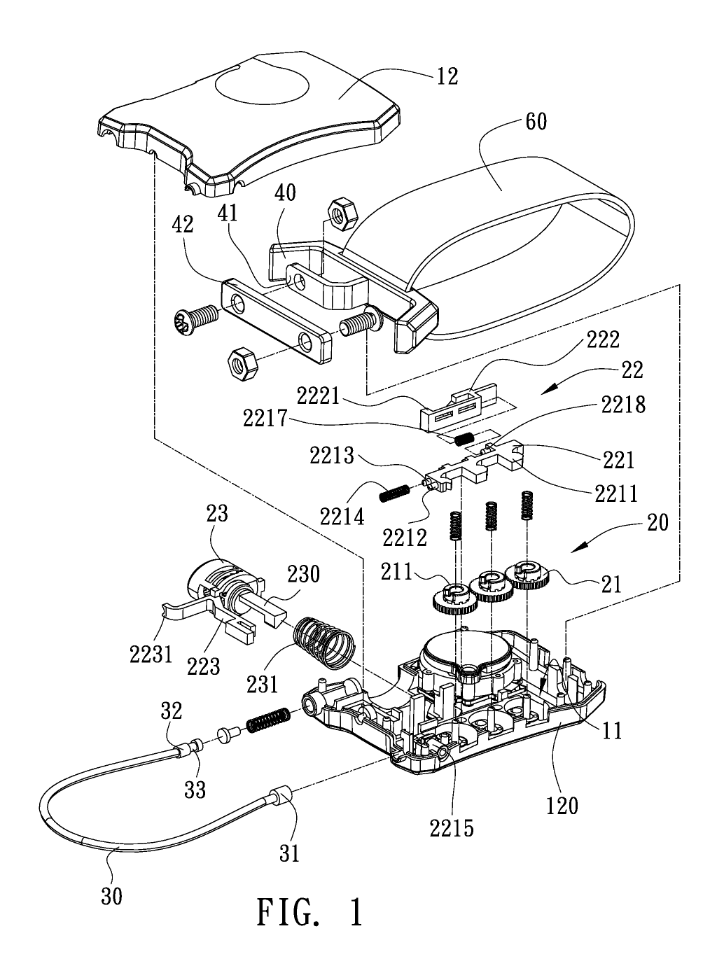

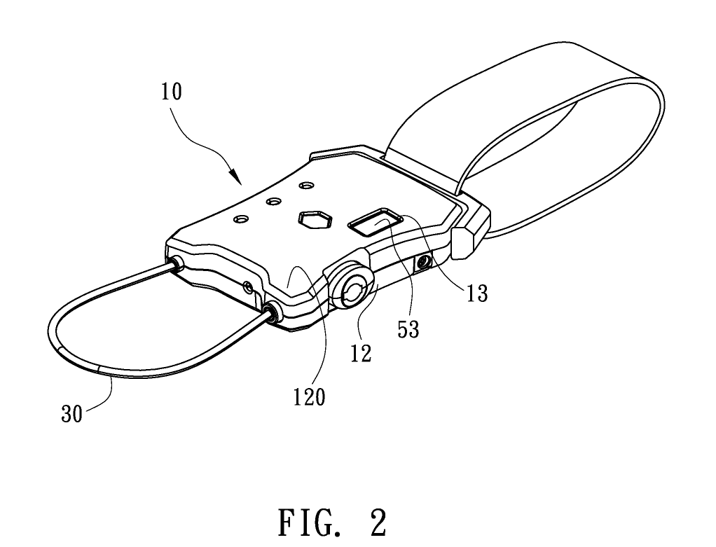

Referring to the drawings and initially to FIGS. 1-4, a weight measure device with a combination lock in accordance with the present invention comprises a casing (10) including a first shell (12) and a second shell (120) abutting each other to define a chamber in the casing (10). A window (13) is defined in the second shell (120) of the casing (10).

The combination lock (20) is received in the chamber (11). The combination lock (20) includes multiple rotors (21) respectively and rotatably mounted on one side of the second shell (120) and linearly corresponding to one another, wherein each rotor (21) has an indentation (211) laterally defined therein. An engage assembly (22) is movably mounted in the chamber (11) and selectively engaged to the rotors (21) and an actuator (23) is provided to drive the engage assembly (22) for unlocking the combination lock (20) when the engage assembly (22) is engaged to the rotors (21).

The engage assembly (22) includes a first latch (221) movably relative to the rotors (21) and the moving direction is parallel to a line of centers of the rotors (21). The first latch (221) includes multiple buckles (2211) extending therefrom and each buckle (2211) is selectively engaged to the indentation (211) of a corresponding one of the multiple rotors (21). A first stub (2212) and a second stub (2213) longitudinally extend from one end of the first latch (221), and a first spring (2214) is compressively sleeved on the second stub (2213) for pushing first latch (221) toward the rotors (21). A random number generator (2215) is mounted in the casing (10) and corresponds to the first stub (2212). The random number generator (2215) provides a group of random number to the combination lock (20) for next operation when sensing the backward moved first stub (2212). A third stub (2218) extends from the first latch (2218) and a second spring (2217) is compressively sleeved on the third stub (228). A second latch (222) is laterally and slidably mounted to the first latch (221), and abuts against a free end of the second spring (2217). The second latch (222) has a block (2221) laterally extending therefrom opposite to the first latch (221). An actuator (23) is inserted into the casing (10) and reciprocally movable relative to the casing (10) for longitudinally driving the second latch (222). The actuator (23) has a shaft (230) longitudinally extending therefrom and having a free end abutting against the second latch (222). A third spring (231) is longitudinally mounted onto the actuator (23) for providing restitution force to the actuator (23) after the actuator (23) being inwardly pressed. An L-shaped pawl (223) is laterally mounted to the actuator (23) and has a first end linearly corresponding to the block (2221) when the combination lock (20) is in a locked position.

A cable (30) includes a first end (31) fixed in the casing (10) and a second end (32) selectively engaged to a second end (2231) of the L-shaped pawl (223) when the combination lock (20) is in a locked condition. The second end (32) of the cable (30) has an annular groove (33) defined therein and the second end (2231) of the L-shaped pawl (223) is engaged into the annular groove (33) when the combination lock (20) is in a locked position. A connector (40) is movably mounted to an outer periphery of the casing (10) opposite to the cable (30). A connecting board (41) extend from the connector (40) into the casing (10) and a sensor (42) has a first end connected to a free end of the connecting board (41) and a second end fixed on an inner periphery of the casing (10). In the preferred embodiment of the present invention, the sensor (42) is a strain gauge.

An electronic unit (50) is disposed in the casing (10) and electrically connected to the sensor (42). The electronic unit (50) includes a battery (51) received in the casing (10) near the sensor (42), a processing unit (52) electrically connected to the battery (51) and the sensor, and a displayer (53) electrically connected to the processing unit (52), wherein the displayer (53) corresponds to the window (13) in the second shell (120). A strap (60) has two opposite ends respectively secured on the connector (40).

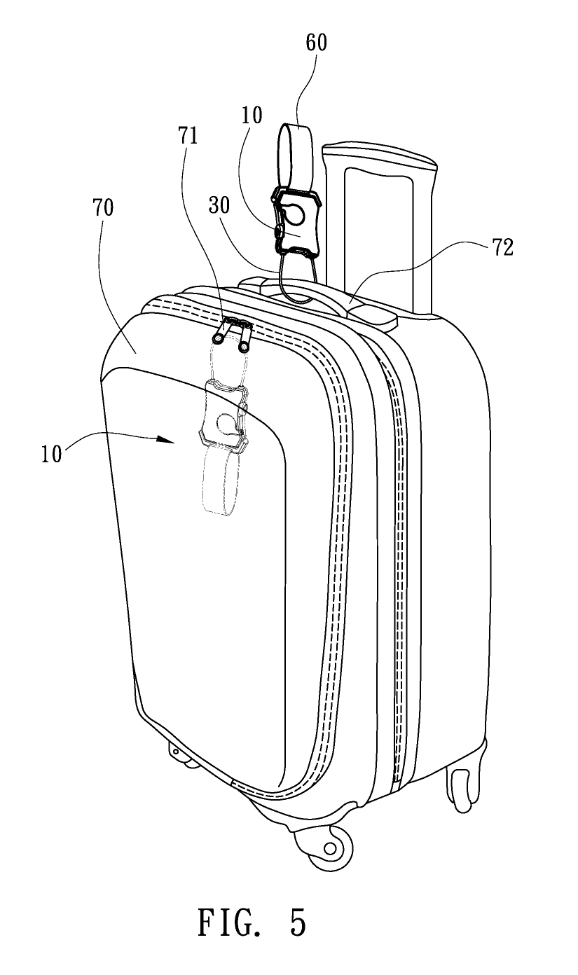

With reference to FIG. 5, when locking the suitcase (70), the second end (32) of the cable (30) sequentially extends through two pull tabs (71) of the zipper of the suitcase (70) and is inserted into the casing (10) to be engaged to the second end (2231) of the L-shaped pawl (223). As a result, anyone can not release the zipper of the suitcase (70) before unlocking the combination lock (20) of the present invention.

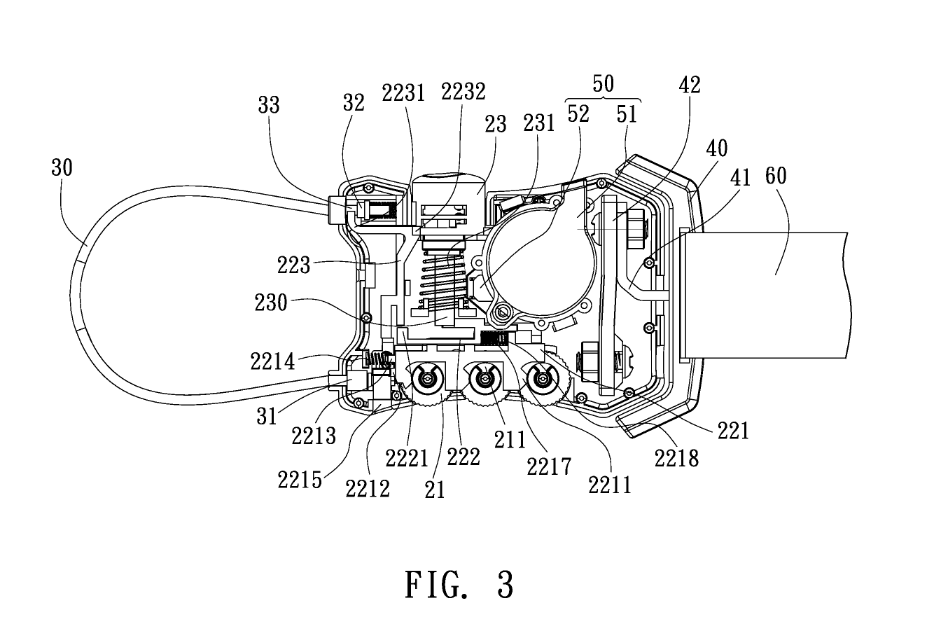

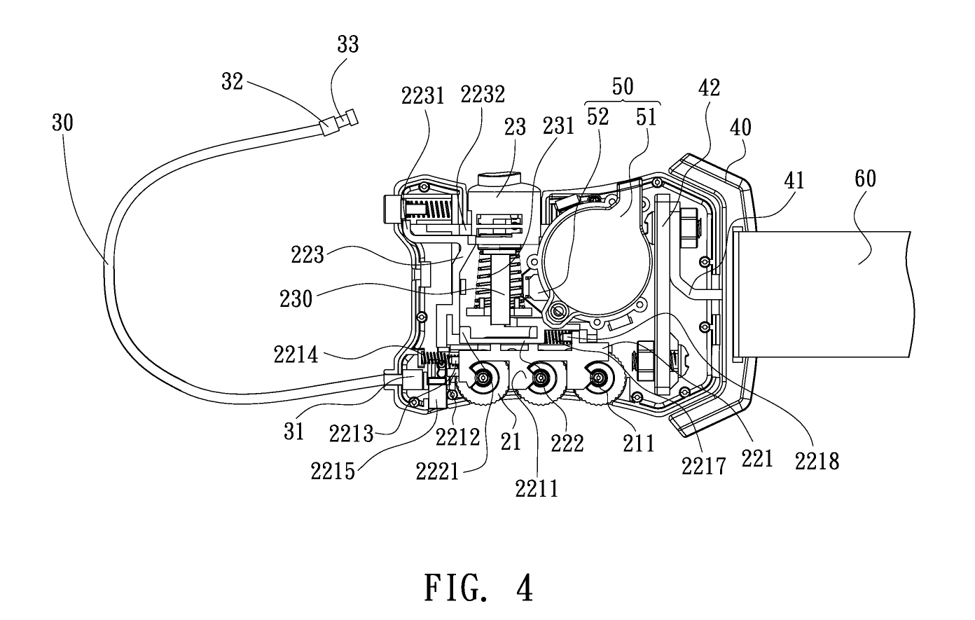

Further with reference to FIGS. 3 and 4, when unlocking the combination lock (20) in accordance with the present invention, each rotor (21) is rotated to make the indentation (211) align with the corresponding buckle (2211). The actuator (23) is inwardly pushed and the shaft (230) drives the second latch (222) with the first latch (221) to make each buckle (2211) being inserted into the corresponding indentation (211) such that the block (2221) is staggered relative to the first end of the L-shaped pawl (223). At the same time, the L-shaped pawl (223) is moved toward the first end (31) of the cable (30) such that the second end (2231) of the L-shaped pawl (223) is detached from the annular groove (33) in the second end (32) of the cable (30). As a result, the second end (32) of the cable (30) can be easily pulled from the casing (10) and the combination lock (20) is in an unlocked condition.

Further with reference to FIG. 5, when measuring the total weight of the suitcase (70), the second end (32) surrounds the handle (72) and inserted into the casing (10), and the combination lock (20) is restored into the locked condition. The sensor (42) is deformed due to the gravity of the suitcase (70) when the operator carries the suitcase (70) to make the suitcase (70) in a suspensory condition. The deform ratio of the sensor (42) is transmitted to the processing unit (52). Accordingly, the processing unit (42) converts the deform ratio of the sensor (42) into a weight unit and shown on the displayer (53). Thus, the operator can easily read the numbers through the window (13).

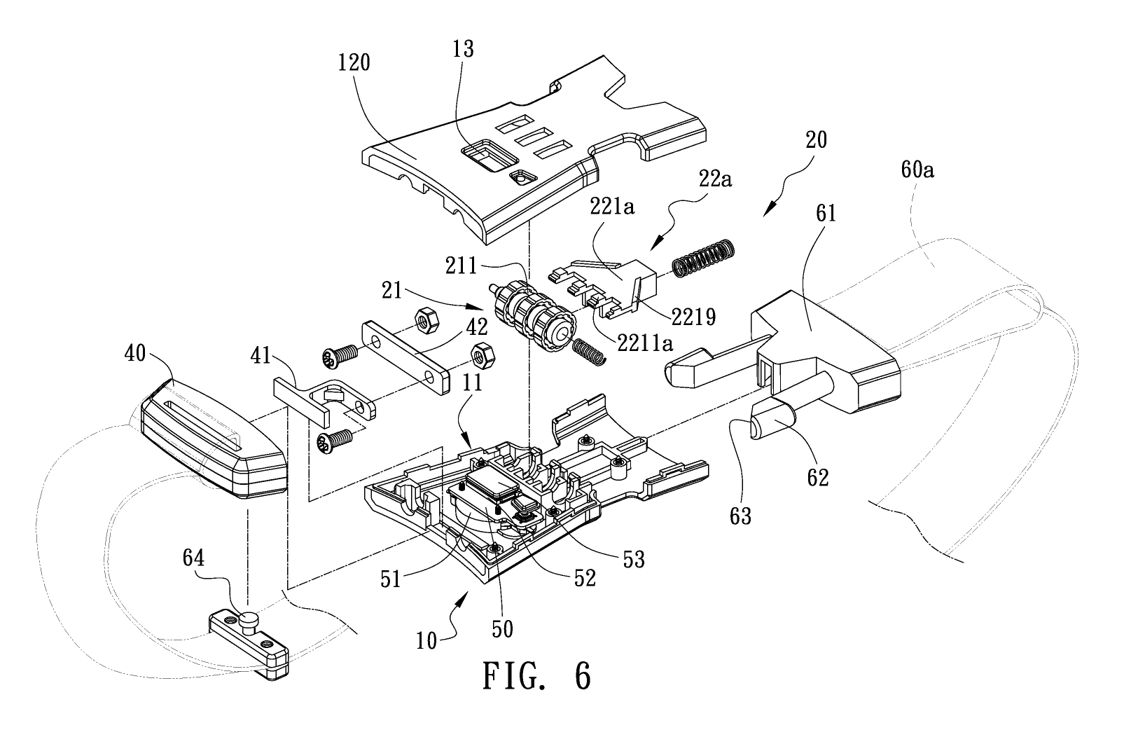

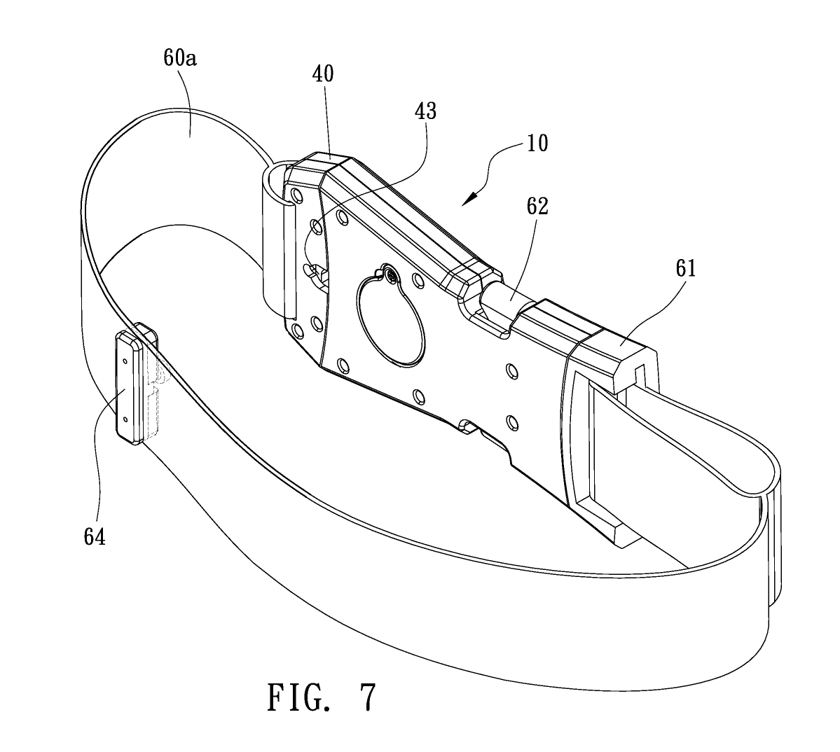

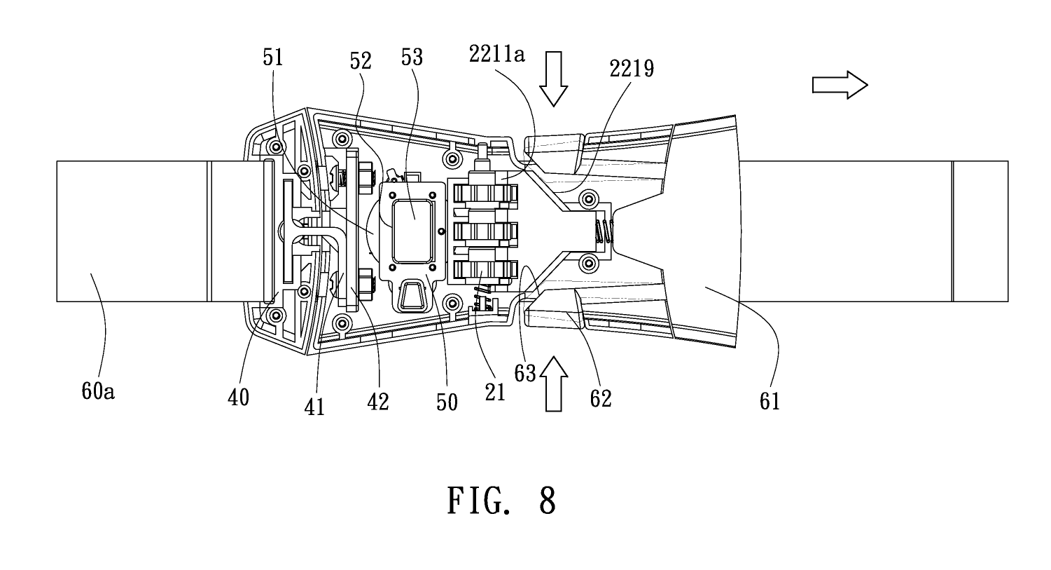

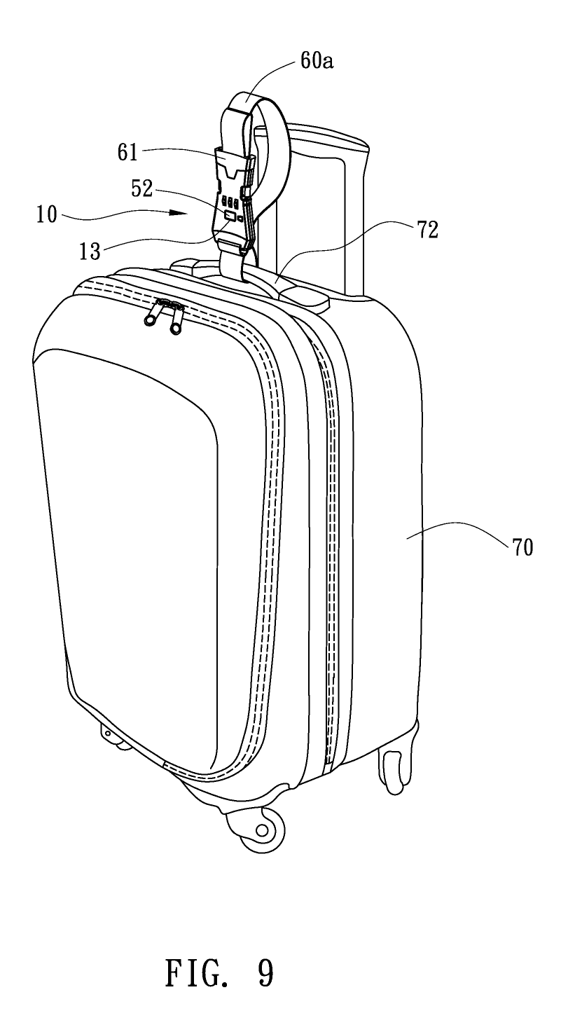

With reference to FIGS. 6 through 9 that show a second embodiment of the weight measure device in accordance with the present invention, hereinafter, the same structures of the first embodiment and the second embodiment are not superfluously described.

The combination lock (20) includes an engage assembly (22a) selectively engaged into the rotors (21) to achieve an unlocked condition. The engage assembly (22a) includes a latch (221a) having multiple buckles (2211a) extending from the latch (221a), wherein each buckle (2211a) is selectively engaged into the indentation (211) in the corresponding rotor (21). The latch (221a) has two first guide planes (2219) respectively formed on two opposite sides thereof.

An actuator (61) is partially mounted into the casing (10) opposite to the connector (40) that has a hole (43) defined therein. The strap (60a) has two opposite ends respectively securely connected to the connector (40) and the actuator (61). An inlay (64) is disposed on the strap (60a) and selectively engaged into the hole (43) in the connector (40). The actuator (61) includes two resilient hooks (62) extending therefrom and outwardly engaged to the casing (10). Each resilient hook (62) has a second guide plane (63) formed on a free end thereof and each second guide plane (63) parallel to a corresponding one of the two first guide planes (2219) on the latch (221a) for pushing latch (221a) when the two resilient hook (62) are inwardly pushed and each buckle (2211a) aligns with the indentation (211) of the corresponding rotor (21).

When measuring the total weight of the suitcase (70), the rotors (21) is rotated to make the indentation (211) of each of the rotors (21) aligning with the corresponding buckle (2211a). Then, the two resilient hooks (62) are inserted into the casing (10) and positioned by extending through the casing (10) after the actuator (61) surrounding the handle (72) and the inlay (64) engaged into the hole (43) in the connector (40). The latch (221a) is moved back to its original position after the two resilient hooks (62) outwardly extending to engaged to the casing (10). Next, the rotors (21) are respectively rotated to make the combination lock (20) into a locked condition. Now, the weight measure device in accordance with the present invention can measure the total weight of the suitcase (70) when hanging the strap (60a). The measure method and display way of the second embodiment is the same as that of the first embodiment, as described above.

When detaching the weight measure device of this embodiment, the rotors (21) is rotated to make the indentation (211) of each of the rotors (21) aligning with the corresponding buckle (2211a). The two resilient hooks (62) can smoothly inwardly pushed and detached from the casing (10) after the latch (221a) being moved toward the rotors (21) and each buckle (2211a) inserted into the corresponding indentation (211).

Although the invention has been explained in relation to its preferred embodiment, it is to be understood that many other possible modifications and variations can be made without departing from the spirit and scope of the invention as hereinafter claimed.

What is claimed is:

1. A weight measure device comprising:
a hollow casing including a first shell and a second shell abutting each other, wherein a window is defined in the second shell, the casing having a first side adapted to be connected to a suitcase;
a combination lock received in the casing, the combination lock including multiple rotors respectively rotatably mounted to the casing and an engage assembly selectively engaged to the rotors, an actuator extending into the casing for driving the engage assembly, wherein the actuator is reciprocally movable relative to the engage assembly;
a connector movably mounted onto a second side of the casing, a connecting board extending from the connector into the casing, a strain gauge having a first end connected to a free end of the connecting board and a second end secured on the casing;
an electronic unit disposed in the casing and electrically connected to the strain gauge, the electronic unit includes a battery received in the casing for providing power thereto, a processing unit electrically connected to the battery and the strain gauge, a displayer electrically connected to the processing unit and corresponding to the window; and
a strap connected to the connector such that the sensor is deformed due to the gravity of the suitcase when the operator carries the suitcase with the strap to make the suitcase in a suspensory condition, wherein the deform ratio of the sensor is transmitted to the processing unit and the processing unit converts the deform ratio of the sensor into a weight unit and shown on the displayer.

2. The weight measure device as claimed in claim 1, wherein each rotor has an indentation laterally defined therein.

3. The weight measure device as claimed in claim 2, wherein the engage assembly includes:
a first latch reciprocally movably relative to the rotors and the moving direction parallel to a line of centers of the rotors, the first latch including multiple buckles extending therefrom and each buckle selectively engaged to the indentation of a corresponding one of the rotors;
a first stub and a second stub respectively longitudinally extending from one end of the first latch, and a first spring compressively sleeved on the second stub for pushing the first latch toward the rotors, a third stub extending from the first latch and a second spring compressively sleeved on the third stub;
a random number generator mounted in the casing and corresponding to the first stub, wherein the random number generator provides a group of random numbers to the combination lock for next operation when sensing the backward moved first stub;
a second latch laterally and slidably mounted to the first latch, and abutting against a free end if the second spring, the second latch having a block laterally extending therefrom opposite to the first latch; and
an actuator inserted into the casing and reciprocally movable relative to the casing for longitudinally driving the second latch.

4. The weight measure device as claimed in claim 3, wherein the actuator includes:
a shaft longitudinally extending therefrom and having a free end abutting against the second latch;
a third spring longitudinally mounted onto the actuator for providing a restitution force to the actuator after the actuator being inwardly pressed;
an L-shaped pawl laterally mounted to the actuator and having a first end linearly corresponding to the block when the combination lock is in a locked position.

5. The weight measure device as claimed in claim 4 further comprising a cable having a first fixed in the casing and a second end selectively to a second end of the L-shaped pawl when the combination lock is in a locked condition.

6. The weight measure device as claimed in claim 5, wherein the second end of the cable has an annular groove defined therein and the second end of the L-shaped pawl is selectively engaged into the annular groove.

7. The weight measure device as claimed in claim 2, wherein the engage assembly includes a latch having multiple buckles extending from the latch, each buckle selectively engaged into the indentation in a corresponding one of the rotors, the latch having two first guide planes respectively formed on two opposite sides thereof.

8. The weight measure device as claimed in claim 7, wherein the actuator is partially mounted into the casing opposite to the connector that has a hole defined therein.

9. The weight measure device as claimed in claim 8 further comprising an inlay disposed on the strap and selectively engaged into the hole in the connector.

10. The weight measure device as claimed in claim 7, wherein the actuator includes two resilient hooks extending therefrom and outwardly engaged to the casing, each resilient hook having a second guide plane firmed on a free end thereof and each second guide plane parallel to a corresponding one of the two first guide planes on the latch for pushing the latch when the two resilient hooks are inwardly pushed and each buckle of the latch aligns with the indentation of the corresponding rotor.
